(19) United States
(12) Patent Application Publication
(10) Pub. No.: US 2026/0001716 A1
(43) Pub. Date: Jan. 1, 2026

(54) RESERVOIR AND METHOD FOR OPERATING THE RESERVOIR

(71) Applicant: G.D S.P.A., Bologna (BO) (IT)

(72) Inventors: Valerio AMORATI, Bologna (BO) (IT); Manuele CUCCHI, Bologna (BO) (IT); Giampaolo GIANESE; Mirco LEGNANI; Luca TESTONI

(21) Appl. No.: 18/880,731

(22) PCT Filed: Jul. 19, 2023
(86) PCT No.: PCT/IB2023/057359

§ 371 Date: Jan. 2, 2025

(30) Foreign Application Priority Data
Jul. 25, 2022 (IT) 102022000015576

(51) Int. Cl. B65G 1/02

(52) U.S. Cl. CPC B65G 1/026

(57) ABSTRACT

A reservoir includes: feed stations, each with a feed transfer device and associated with a feed line for feeding components; a pickup station with a pickup transfer device associated with a removal line for removing articles; a movable support with receiving seats for individual articles and movable along a closed path through the feed stations and the pickup station so that two or more components for each article are fed to each receiving seat of the movable support by the feed transfer devices to form an article and the articles are removed from the movable support by the pickup transfer device; a control unit to drive the transfer devices as a function of current capacity values of the feed lines and of the removal line. The reservoir creates a combination of the components, forming a corresponding article, while the components are moved from the feed lines to the removal line.

### TECHNICAL FIELD

This invention relates to a reservoir and to a method for operating the reservoir.

The invention addresses the sector of industrial processes for the production, processing and packaging of articles in general. The type of articles, therefore, is not a limiting factor in the context of this invention. Whatever the case, by “article” is meant, preferably, a single object which can be gripped, transported and released individually. By way of a non-exhaustive example, the following may be considered articles according to this invention: food or confectionery products; components or sub-units of electronic cigarettes; electronic components; small mechanical parts.

### BACKGROUND ART

Known in the prior art are product reservoirs, multi-level in some cases, provided with input and output transfer devices which store the products in a storage area.

In some production lines, the products stored are semiproducts or components which are subsequently assembled and used for the production of articles.

### DISCLOSURE OF THE INVENTION

The Applicant has found that these production lines can be improved in terms of floor space requirements, in particular in terms of compactness.

In this context, the basic technical purpose of this invention is to provide a reservoir and a method for operating the reservoir to overcome the above mentioned disadvantages of the prior art.

In particular, the aim of this invention is to provide a reservoir and a method for operating the reservoir which are highly compact, in particular in terms of the floor space needed for the operations to be carried out.

The technical purpose indicated and the aim specified are substantially achieved by a reservoir and a method for operating the reservoir comprising the technical features set out in claims 1 and 9 and/or in one or more of the claims dependent thereon.

### BRIEF DESCRIPTION OF THE DRAWINGS

Further features and advantages of the invention are more apparent in the non-limiting description which follows of a preferred but non-exclusive embodiment of a reservoir and a method for operating the reservoir, as illustrated in the accompanying drawings, in which:

FIG. 1 is a simplified perspective view of a reservoir according to this invention, in a first embodiment;

FIG. 2 shows a schematic plan view of the reservoir of FIG. 1;

FIG. 3 is a simplified perspective view of a reservoir according to this invention, in a second embodiment;

FIG. 4 is a simplified perspective view of a reservoir according to this invention, in a third embodiment;

FIGS. 5A-5C schematically represent three operating steps performed by the reservoir according to the invention in a first embodiment thereof;

FIGS. 6A-6C schematically represent three operating steps performed by the reservoir according to the invention in a second embodiment thereof.

### DETAILED DESCRIPTION OF PREFERRED EMBODIMENTS OF THE INVENTION

The numeral 1 in the accompanying drawings denotes in its entirety a reservoir according to this invention, suitable for the temporary storage of articles.

In the context of this invention, the term “articles” is used to denote products of diverse kinds such as, by way of non-limiting example: food or confectionery products; components or sub-units of electronic cigarettes; electronic components; small mechanical parts.

Regardless of the type of product, the reservoir 1 is suitable for working between at least two production lines upstream and at least one processing or packaging line downstream, to hold or deliver articles when the capacities of the lines upstream and downstream are imbalanced.

In an embodiment, the reservoir 1 is a “dynamic” reservoir, that is to say, suitable for the temporary storage of articles based on one or more criteria which take into account how full it is at any time, hence not necessarily linked to a sequential order of filling.

Moreover, the reservoir 1 is of a mobile type, that is to say, normally mobile in such a way as to move the articles and the respective housings cyclically, in particular with continuous and/or uniform motion.

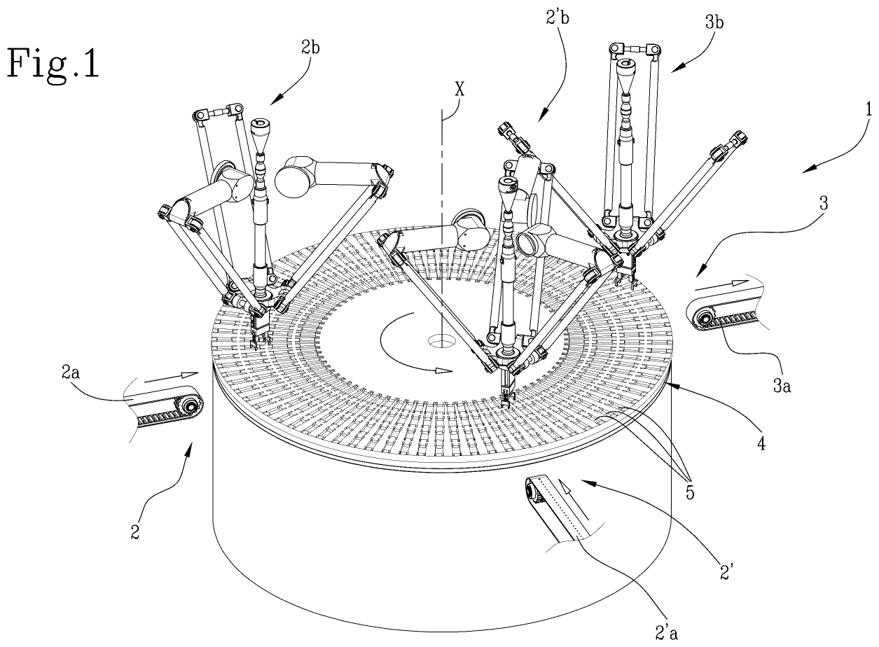

Looking in more detail, as shown in FIG. 1, the reservoir 1 comprises two (or more) feed stations 2, 2′ each associated or associable with at least one respective feed line 2a, 2′a for feeding articles and equipped with a respective feed transfer device 2b, 2′b and one (or more) pickup stations 3, each associated or associable with at least one respective removal line 3 for removing articles and equipped with a respective pickup transfer device 3b.

The reservoir 1 also comprises a movable support 4 provided with a plurality of receiving seats 5 for receiving single articles (not illustrated) and configured to move the receiving seats 5 along a closed path passing through the feed stations 2, 2′ and the pickup station 3 so that the articles are fed to the movable support 4 by the feed transfer devices 2b, 2′b and the articles are removed from the movable support 4 by the pickup transfer device (or devices) 3b.

The reservoir 1 is configured to move individual articles towards and away from the movable support 4; in other words, the transfer devices 2b, 2′b, 3b are configured to pick up, transfer and release one single article at a time (according to the embodiment illustrated). Alternatively, the transfer devices 2b, 2′b, 3b may be configured to pick up, transfer and release a group of articles at a time.

The transfer devices 2b, 2′b, 3b illustrated are in the form of articulated arms; they may, however, be embodied in any form, for example, Cartesian actuators, anthropomorphic robots and so on.

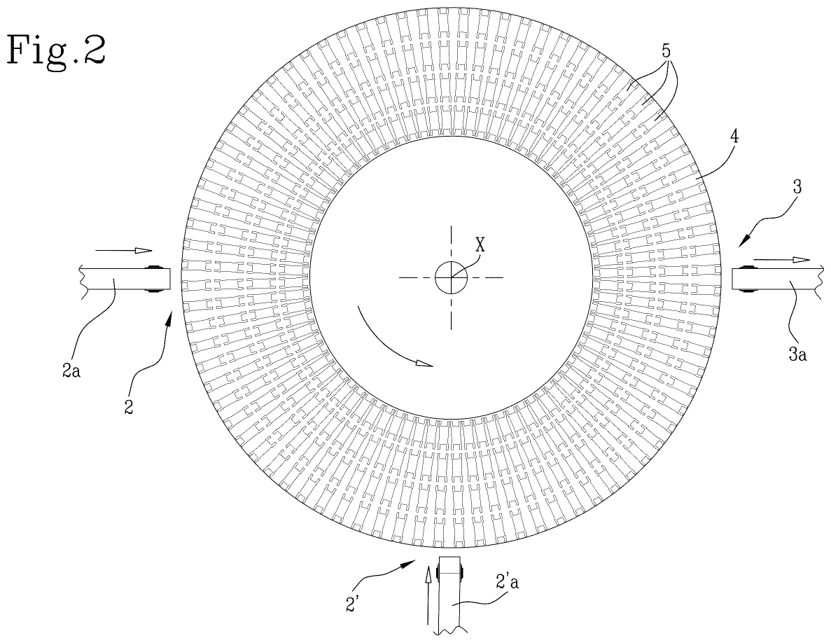

Preferably, the receiving seats 5 are distributed on the movable support 5 according to a two-dimensional distribution, in particular, in a plurality of longitudinal rows (circles) running alongside each other, as shown in FIG. 2.

The movable support 4 is made preferably in the form of a carousel or rotary disc, in particular, rotating about a vertical axis X. The carousel or rotary disc has an integral structure, that is to say, all the receiving seats 5 are movable along the closed path simultaneously.

Preferably, the movable support 4 moves with continuous motion, in particular at a constant speed, along the closed path.

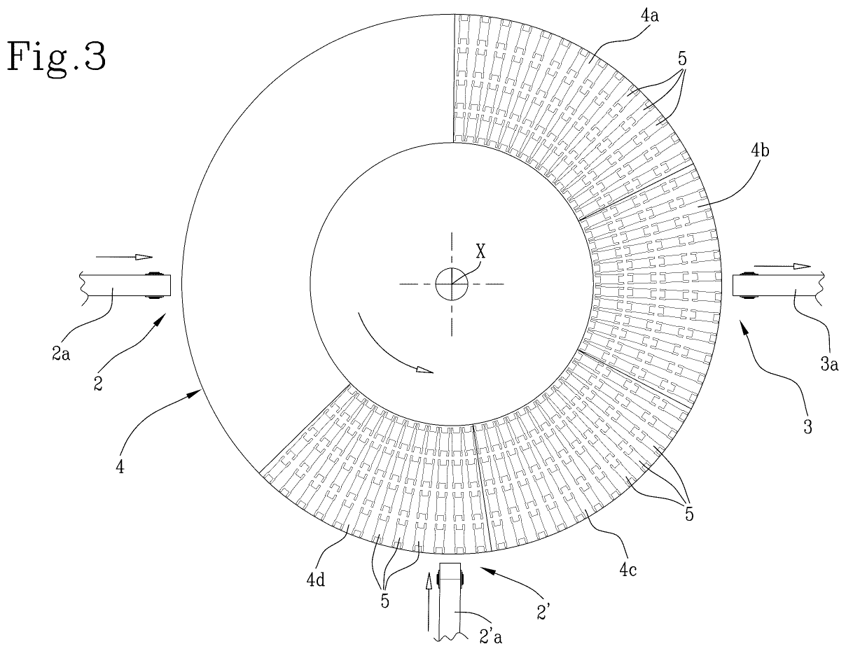

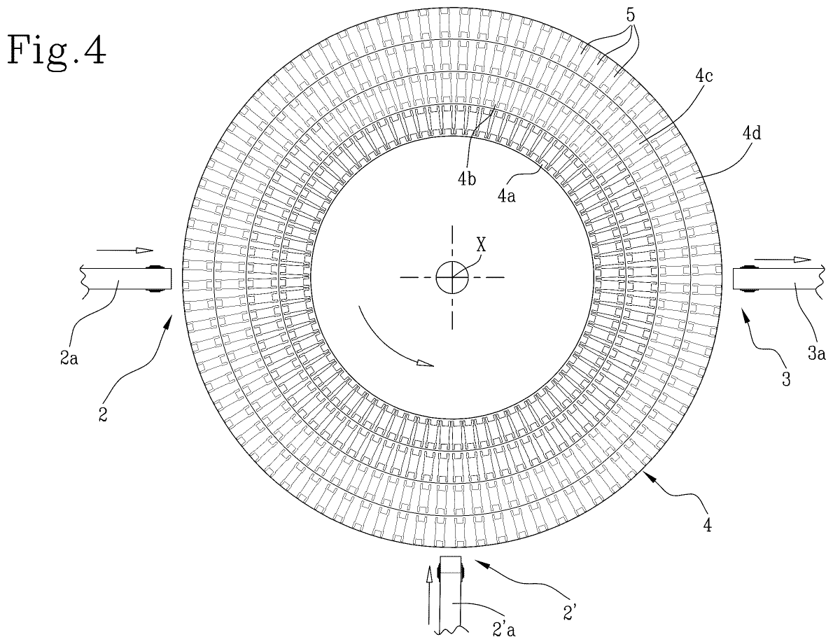

Alternatively, as shown in FIGS. 3 and 4, the movable support 4 comprises a plurality of sectors 4a, 4b, 4c, 4d, each having a plurality of receiving seats 5 and movable independently of each other along the closed path. There may be any number of sectors, preferably two, three, four or more than four.

In the embodiments illustrated in FIGS. 3 and 4, there are four such sectors. The sectors 4a, 4b, 4c, 4d define respective planar supporting surfaces, provided with receiving seats 5, and coplanar with each other. The supporting surfaces cooperate to define a single, substantially uninterrupted supporting surface of the movable support 4. The sectors 4a, 4b, 4c, 4d each comprise a respective independent motor (not illustrated) to move the respective sector 4a, 4b, 4c, 4d along the closed path. The motor may be housed in a supporting base of the sectors 4a, 4b, 4c, 4d and may comprise, for example, rack and pinion means or linear motors.

In the embodiment of FIG. 3, the sectors 4a, 4b, 4c, 4d are angular sectors, each having an angular size of 60°, so as to cover a total angle of 240°. More generally speaking, regardless of their number, the angular sectors define a total angle of less than 360° and, in particular, between 180° and 300°. Furthermore, the angular sectors preferably have the same angular size and, more preferably, are identical. Preferably, the receiving seats 5 are distributed on each circular sector 4a, 4b, 4c, 4d according to a two-dimensional distribution over the entire angular extension of the sectors 4a, 4b, 4c, 4d or over a part thereof.

In the embodiment of FIG. 4, the sectors 4a, 4b, 4c, 4d are circular sectors having a preferably closed (annular) shape and being coaxial with each other. The circular sectors 4a, 4b, 4c, 4d are radially nested into each other so as to be disposed in sequence along a radial direction towards the axis X. Preferably, in this case too, the receiving seats 5 are distributed on each circular sector 4a, 4b, 4c, 4d according to a two-dimensional distribution over the entire circumferential extension of the sectors 4a, 4b, 4c, 4d or over a part thereof.

Preferably, the reservoir 1 also comprises detecting means (not illustrated) for detecting a filled condition of at least some of the receiving seats 5. In particular, the detecting means can detect a filled condition only of the receiving seats 5 that are currently within the operating ranges of the transfer devices 2b, 2′b, 3b, or a filled condition of the receiving seats 5 located in portions of the movable support 4 outside the operating ranges of the transfer devices 2b, 2′b, 3b, or a filled condition of all the receiving seats 5 on the movable support 4.

Preferably, the detecting means are configured to detect the filled condition at predetermined time intervals, in particular, at time intervals preferably shorter than the time that elapses between the passage of one receiving seat 5 and the next receiving seat 5. More preferably, detection occurs at a frequency greater than or equal to 5 Hz, which, in the context of this use, corresponds to continuous or “quasi-continuous” detection.

In a preferred embodiment, the detecting means comprise one or more cameras, for example, located above the movable support 4.

In an alternative solution, the detecting means are presence sensors inside each receiving seat 5 and configured to generate an article present and/or absent signal at the aforesaid predetermined frequency or to detect an absent/present variation condition and vice versa.

The detecting means thus generate respective (optical and/or electrical) signals identifying the filled condition of at least some of the receiving seats 5 of the movable support 4.

The reservoir 1 also comprises a control unit (not illustrated) connected to the transfer devices 2b, 2′b, 3b and configured to drive the transfer device 2b, 2′b, 3b as a function of the current capacity values of the feed lines 2a, 2′a and of the removal line 3a. In particular, the control unit is configured to drive each transfer device 2b, 2′b, 3b independently and at a variable transfer frequency or speed, for example, greater if the respective feed/removal line 2a, 2′a, 3a is fully operational, and smaller if the respective feed/removal line 2a, 2′a, 3a is operating at a reduced capacity (for example, on account of slowdowns in production or processing units upstream), and even to stop the transfer device 2b, 2′b, 3b completely if the respective feed/removal line 2a, 2′a, 3a is down.

In the context of this disclosure, the expression “current capacity” means the quantity (or flow) of articles per unit time at a given instant (measured, for example, in articles/second or articles/minute).

Furthermore, the control unit is connected to the detecting means and configured to operate according to a programmed logic of driving the transfer devices 2b, 2′b, 3b as a function of the filled conditions received from the detecting means, so as to place the articles in receiving seats 5 detected as being currently available and/or to pick up articles from receiving seats 5 detected as currently containing an article.

In particular, therefore, the control unit comprises one or more drive logics used to determine the sequence of releasing the articles into the receiving seats 5 or picking up the articles from the receiving seats 5, taking into account not only the current capacity conditions of the feed lines 2a, 2′a and of the removal line 3a but also the current distribution of the articles (full/empty seats 5) on the movable support 4.

For example, with reference to the embodiment of FIGS. 1 and 2, the control unit may be configured to make the articles distributed on the movable support 4 more closely packed or thinned out, in particular progressively and evenly over the whole surface of the movable support 4, so as to prevent individual sub-areas of the movable support 4 from being filled completely (or emptied completely), while other sub-areas are, at the same time, only partially filled). This has the effect of optimizing the distribution of the articles in that, mainly in the case of continuous advancing motion of the receiving seats 5 along the closed path, each feed station 2 would always have empty receiving seats 5 available to it, and each removal station 3 would always have available it full receiving seats 5 from which articles can be picked up. If this were not the case, hence in the case of areas (or “islands”) that are all full or all empty, the corresponding feed station 2 or removal station 3 would have to stop and wait for the next instant, thereby going “out of step” or creating delays which, in some operating conditions, might not be able to be compensated.

The effect of packing more closely or of thinning out must be understood as “distributed” over the entire surface of the movable support 4 and not only locally in specific areas thereof.

In other words, therefore, the control unit contains one or more drive logics, such as to:
drive the feed transfer devices 2b. 2′b in such a way as to gradually make the articles more closely packed on the movable support 4 gradually by not filling some areas completely, excepting the completely full condition that would take place in the last cycle (rotation) of the movable support 4; and/or
drive the pickup transfer device 3b in such a way as to gradually thin out the articles on the movable support 4 gradually by not emptying some areas completely, excepting the completely empty condition that would take place in the last cycle (rotation) of the movable support 4.

In an example embodiment, a control logic might be that of releasing the articles onto the movable support 4 in order to fill it in “checkerboard” or similar fashion, to create a predetermined number of alternate empty and full receiving seats 5, and similarly, to pick up the articles from the movable support 4 so that the articles remaining are also arranged in “checkerboard” fashion.

With reference to the embodiments of FIGS. 3 and 4, the control unit is, instead, configured for moving the sectors 4a, 4b, 4c, 4d independently, for example, in such a way that each feed transfer device 2b, 2′b operates on the same sector 4a, 4b, 4c, 4d, until that sector 4a, 4b, 4c, 4d is completely full before starting to work on another sector 4a, 4b, 4c, 4d and/or in such a way that the pickup transfer device 3b operates on the same sector 4a, 4b, 4c, 4d, until that sector 4a, 4b, 4c, 4d is completely empty before starting to work on another sector 4a, 4b, 4c, 4d.

According to the invention, each feed line 2a, 2′a feeds a respective component 100, 200 and the components 100, 200 fed by different feed lines 2a, 2′a are suitable for at least partly forming a respective article by combining them or assembling them to each other. For example, the components 100, 200 are intended to be combined by surface mounting, screwing, gluing, welding, slotting, shape coupling or other means. The term “article” is used broadly to mean both a product ready for sale or use and a semiproduct to be subjected to further processing after it leaves the reservoir 1. In an embodiment, the components 100, 200 are components of different kinds (for example, differing in shape, colour, structure, size, material, etc.), in particular complementing each other. In a different embodiment, the components 100, 200 are identical and can simply be identified as “first components 100” and “second components 200”, distinguishable only because of the different feed line 2a, 2′a they come from.

Thus, the components 100, 200 intended to form each article A are fed to the movable support 4 by the respective feed transfer devices 2b, 2′b, while the articles A are removed from the movable support 4 by the pickup transfer device 3b.

The feed transfer devices 2b, 2′b are configured and/or controlled in such a way as to feed the respective components 100, 200 of a single article A to the same receiving seat 5 so as to form an article A by combining the respective components 100, 200 while the movable support 4 is being moved along the closed path, hence while the receiving seat 5 is being moved towards the pickup station 3.

According to the invention, therefore, the different components 100, 200 intended to form the same article A are fed to the same receiving seat 5 at different times, for example, during the same stroke of the movable support 4 (each receiving seat 5 reaches the different feed stations 2, 2′ at different moments) or during distinct rotation cycles. In effect, the control unit might drive the transfer devices 2b, 2′b, 3b in such a way as to exclude one of the feed transfer devices 2b, 2′b (for example, if the respective feed line 2a, 2′a stops) and in such a case, the other feed transfer device continues placing the respective component in the receiving seats 5, which will receive the other component only when the feed transfer device 2b, 2′b which has temporarily stopped starts operating again. Alternatively, the release logic by which the components 100, 200 are released by the feed transfer devices 2b, 2′b may be such as to not necessarily be intended to combine one component with another which has already been placed, meaning that the components released by the two feed transfer devices 2b, 2′b are totally independent of each other.

Preferably, the reservoir 1 is also configured to perform at least one operation on and/or with the components 100, 200 inside the same receiving seat 5, where that operation is performed while the movable support 4 moves along the closed path and comprising at least one of the following: screwing, gluing, welding, slotting, shape coupling.

In an embodiment, the operation is performed by at least one respective feed transfer device 2b, 2′b (for example, the moment the respective component 100, 200 is released into the receiving seat 5) and/or pickup transfer device 3 (for example, the moment the article A is picked up from the receiving seat 5).

In addition, or alternatively, in a variant not illustrated, the operation is performed by at least one working station, disposed along the closed path and distinct from the feed transfer devices 2b, 2′b and the pickup transfer device 3b, in particular disposed between the feed transfer devices 2b, 2′b and the pickup transfer device 3b.

In particular, the invention contemplates the possibility that one or more of these operations be performed by at least one respective feed transfer device 2b, 2′b or pickup transfer device 3b and/or that one or more further operations be performed by at least one working station.

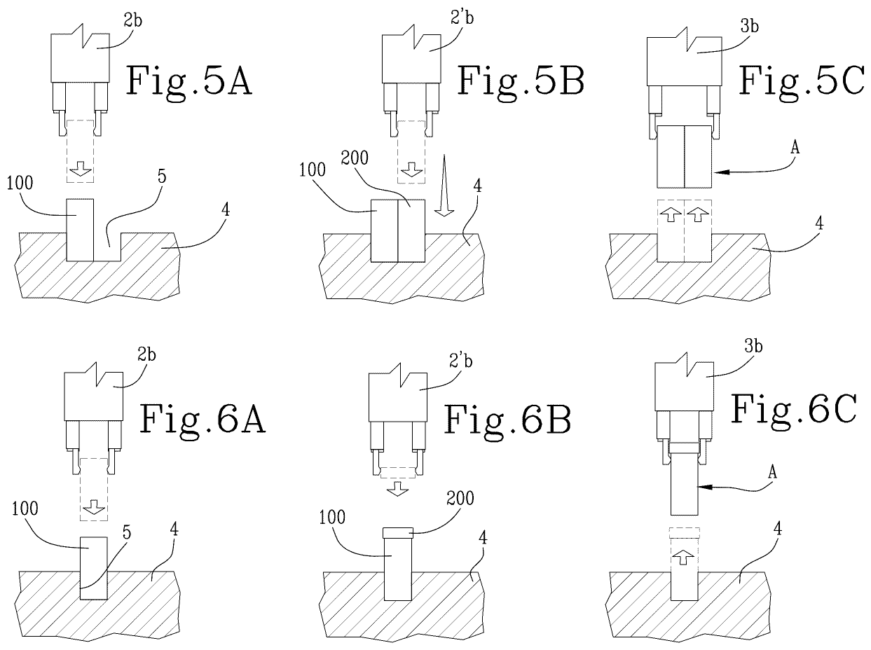

FIGS. 5A-5C show a first example embodiment, where the two components 100, 200 are complementary components which are laterally juxtaposed with each other, for example, containers for liquids or batteries for use as components of electronic cigarettes. In a first step, (FIG. 5A), the first component 100 is fed to a receiving seat 5 by the first feed transfer device 2b, after which the second feed transfer device 2′b inserts the second component 200 into the same receiving seat 5, alongside the first component 100 (FIG. 5B). When both the components 100, 200 have been inserted, hence making an article A, the pickup transfer device 3b picks up and removes the article A from the receiving seat 5 and delivers it to the removal line 3a.

It is specified that by “receiving seat 5” is meant the seat that is intended to receive the components 100, 200 which form the article A. With reference to FIGS. 5A-5C, the receiving seat 5 illustrated is in the form of a housing shaped to receive both components 100, 200. Alternatively, the receiving seat 5 might comprise two housings (for example, with a separator between them) each shaped to receive a respective component 100, 200. This specification applies to any of the embodiments of the reservoir 1 described above.

FIGS. 6A-6C show a second example embodiment, where the two components 100, 200 comprise a container and a lid able to be coupled to the container, for example, by screwing or pressure. The second example embodiment is, in terms of process, the same as the first example embodiment.

According to another aspect of the invention, the reservoir 1 may also comprise further processing stations (not illustrated) suitable for carrying out one or more additional operating steps such as, for example (but not limited to) one or more of the following: applying additional elements, welding, optical inspection or inspection by radiation, applying labels, mechanical processing (boring, milling or the like).

In a different embodiment, not illustrated, the components 100, 200 are combined to form the article A downstream of the movable support 4, in particular at the pickup station 3 or downstream of the pickup station 3. Preferably, this is done by combining the components 100, 200 with each other the moment they are placed on the removal line 3a. Preferably, combining is carried out by the pickup transfer device 3b, or where there are two or more pickup transfer devices 3b (for example, one for each type of component 100), by these pickup transfer devices 3b.

In such a case, the receiving seats 5 of the movable support 4 may comprise at least a first set of receiving seats 5 for a first type of component 100 and second set of receiving seats 5 for a second type of component 200, and the receiving seats 5 of each set are preferably identical to each other and different from the receiving seats 5 of the other set. For example, the first and the second receiving seats 5 may be made on distinct sectors of the movable support 4 or they may be intermingled in an ordered arrangement. More generally speaking, therefore, the invention comprises combining the components 100, 200 while the components 100, 200 are being moved from the feed lines 2a, 2′a to the removal line 3a.

Also in this embodiment, the aforementioned at least one operation carried out on the components may be carried out by the pickup transfer device 3b or by at least one working station located along the removal line 3a, for example, at the release zone where the components 100, 200 are released onto the removal line 3a.

This invention achieves the preset aim, overcoming the disadvantages of the prior art.

In effect, configuring the reservoir like an assembly unit allows reducing the number of working stations needed to form the articles, making the most of the time the components/articles remain (are stored) on the movable support to assemble them and, if necessary, perform other processes. The result is a compact configuration with a high process density.

1. A reservoir, comprising:
a plurality of feed stations, each equipped with a feed transfer device and associated or associable with at least one respective feed line for feeding components;
at least one pickup station equipped with at least one pickup transfer device and associated or associable with at least one respective removal line for removing articles;
a movable support provided with a plurality of receiving seats and configured to move the receiving seats along a closed path passing through the feed stations and the pickup station so that the components are picked up from the respective feed lines and fed to each receiving seat of the movable support by the respective feed transfer devices and the components are removed from the movable support and released onto the removal line by the pickup transfer device;
a control unit connected to the transfer devices and configured to drive the transfer devices as a function of current capacity values of the feed lines and of the removal line,
wherein the reservoir is configured to create a combination of the components, forming a corresponding article, while the components are being moved from the feed lines to the removal line.

2. The reservoir according to claim 1, wherein the feed transfer devices are configured and/or controlled in such a way as to feed the respective components, intended for making the same article, to the same receiving seat so as to form an article by combining the respective components while the movable support is being moved along the closed path, and wherein the pickup transfer device is configured and/or controlled in such a way as to simultaneously pick up the components forming the article from each receiving seat and placing the article on the removal line; the receiving seats being preferably identical.

3. The reservoir according to claim 1, wherein the feed transfer devices are configured and/or controlled in such a way as to feed the respective components to respective, distinct receiving seats so that each receiving seat contains one or more components of the same type, and wherein the at least one pickup transfer device is configured and/or controlled in such a way as to pick up single components from the respective receiving seats and to combine the components with each other on the removal line to form an article, the receiving seats of the movable support preferably comprising at least a first set of receiving seats for a first type of component and a second set of receiving seats for a second type of component, the receiving seats of each set being preferably identical to each other and different from the receiving seats of the other set.

4. The reservoir according to claim 1, wherein the reservoir is also configured to perform at least one operation on and/or with the components inside the same receiving seat, the at least one operation being performed while the movable support is moving along the closed path and comprising at least one of the following: screwing, gluing, welding, slotting, shape coupling.

5. The reservoir according to claim 4, wherein the at least one operation is performed by at least one respective feed transfer device and/or pickup transfer device.

6. The reservoir according to claim 4, wherein the at least one operation is performed by at least one working station, disposed along the closed path and distinct from the feed transfer devices and the pickup transfer device, in particular disposed between the feed transfer devices and the pickup transfer device.

7. The reservoir according to claim 1, further comprising detecting means for detecting a filled condition of at least some of the receiving seats, and wherein the control unit is connected to the detecting means and is configured to drive the transfer devices as a function of the filled conditions received from the detecting means, so as to place the components in receiving seats detected as being currently available and/or to pick up articles from receiving seats detected as currently containing an article.

8. The reservoir according to any one of the preceding claims, claim 1, wherein all the receiving seats are movable along the closed path simultaneously.

9. A method for operating a reservoir, in particular a reservoir according to any one of the preceding claims, claim 1, wherein the reservoir comprises a plurality of feed stations, each equipped with a respective feed transfer device and associated with at least one respective feed line for feeding components; at least one pickup station equipped with a pickup transfer device and associated with at least one respective removal line for removing articles; and a movable support equipped with a plurality of receiving seats, each for receiving respective components from respective feed transfer devices to form a corresponding article, the method comprising the following steps:
moving the movable support in such a way as to move the receiving seats along a closed path passing through the feed stations and the pickup station so that the different components of each article are fed to the movable support by the respective feed transfer devices and the articles are removed from the movable support by the pickup transfer device;
driving the transfer devices as a function of current capacity values of the feed lines and of the removal line;
wherein the different components of the same article are combined with each other to form a corresponding article while the components are being moved from the feed lines to the removal line.

10. The method according to claim 9, wherein the different components of the same article are fed by the feed transfer devices to the same receiving seat so as to form an article while the movable support is moving towards the pickup station.

11. The method according to claim 9, wherein components of a different type are fed to respective, distinct receiving seats in such a way that each receiving seat contains one or more components of the same type, and wherein the single components are picked up from the respective receiving seats and combined with each other on the removal line to form an article, wherein the receiving seats of the movable support comprise at least a first set of receiving seats, into which at least one component of a first type is inserted, preferably exclusively, and a second set of receiving seats, into which at least one component of a second type is inserted, preferably exclusively, the receiving seats of each set being preferably identical to each other and different from the receiving seats of the other set.

12. The method according to claim 9, further comprising a step of performing at least one operation on and/or with the components inside the same receiving seat, the at least one operation being performed while the movable support is moving along the closed path and comprising at least one of the following:
screwing, gluing, welding, slotting, shape coupling.

13. The method according to claim 12, wherein the at least one operation is performed by at least one respective feed transfer device and/or pickup transfer device.

14. The method according to claim 12, wherein the at least one operation is performed by at least one working station, disposed along the closed path and distinct from the feed transfer devices and the pickup transfer device, in particular disposed between the feed transfer devices and the pickup transfer device.

15. The method according to claim 9. wherein the components fed by different feed transfer devices are different from each other and mutually compatible or shaped to match each other to at least partly form a respective article.

16. The method according to claim 9. further comprising a step of detecting a filled condition of at least some of the receiving seats, wherein the step of driving the transfer devices is also carried out as a function of the detected receiving seats filled conditions, so as to place the components in receiving seats detected as being currently available and/or to pick up articles from receiving seats detected as currently containing an article.

17. The method according to claim 9, wherein all the receiving seats are moved along the closed path simultaneously.
